(19) United States
(12) Patent Application Publication
(10) Pub. No.: US 2021/0102631 A1
(43) Pub. Date: Apr. 8, 2021

(54) DIVERTER VALVE

(71) Applicant: Sébastien TERMET, Sainte Marine (FR)

(72) Inventor: Sébastien TERMET, Sainte Marine (FR)

(21) Appl. No.: 16/496,810

(22) PCT Filed: Mar. 26, 2018
(86) PCT No.: PCT/FR2018/000068

§ 371 Date: Sep. 23, 2019

(30) Foreign Application Priority Data
Mar. 24, 2017 (FR) 1752444

(51) Int. Cl. F16K 11/076; B65G 53/56; A01K 61/80

(52) U.S. Cl. CPC F16K 11/076; B65G 2201/042; A01K 61/80; B65G 53/56

(57) ABSTRACT

A distribution valve positioned in a supply pipe, the distribution valve including a body between a first end and a second end, the first end is substantially flat in which an inlet orifice is positioned, the inlet orifice has a circular shape and includes an axis of revolution positioned according to a parallel of the longitudinal axis of the distribution valve, the second end is substantially flat and comprises a spherical cap on which at least two outlet orifices are positioned, each outlet orifice has a circular shape, the distribution valve includes a mobile plug contained in the distribution valve body, the mobile plug includes a rigid duct that passes through it and is adapted for selectively making the inlet orifice communicate with one of the outlet orifices.

### CROSS REFERENCE TO RELATED APPLICATIONS

This application is a National Stage of International Application No. PCT/FR2018/000068, having an International Filing Date of 26 Mar. 2018, which designated the United States of America, and which International Application was published under PCT Article 21(2) as WO Publication No. 2018/172638 A1, which claims priority from and the benefit of French Patent Application No. 1752444, filed on 24 Mar. 2017, the disclosures of which are incorporated herein by reference in their entireties.

### BACKGROUND

### 1. Field

The presently disclosed embodiment relates to a distribution valve.

It also relates to the description of a system for distribution of granules for the farming of aquatic animals. The distribution valve applies, for example, to aquaculture and in particular land-based pisciculture for growing, stocking, and research laboratories.

### 2. Brief Description of Related Developments

Often, animal feed is fragile and friable. Loaded with lipids, it is composed of powders compacted at high temperatures according to the various methods of the providers of pellets. Regardless of the method, the pellets for fish are very fragile. With a particle size distribution from 1 to 13 mm, farms implement rations that can reach 300 kg in tanks 60 m-long and 6 m-wide, according to other examples 150 m-long. The ratio between the length of a tank and its width is 1/10 (in general). These tanks can reach several hundred metres.

There are three types of pellets: sinking (dense), semi-floating, floating. The fragility of the pellet is proportional to its compactness, thus to its type and to its particle size distribution. For a particle size distribution and an equal temperature, a floating pellet is therefore more fragile, than a sinking pellet. The temperature of a pellet is also an important element: brittle when it is cold, and friable (crumbles) with a high temperature.

The structure of a distribution valve must forbid as best as possible the appearance of zones of retention and of stagnation of residual feed. Indeed, these residual stocks disturb the distribution of the programmed doses in several ways. They reduce the final ration distributed since the residual stocks will not reach the animals.

There is a risk of them being added later to a ration intended for another enclosure, and which will pass through the shared part of the network including the valve in question. In this case both the quantity added and the nature of the residual feed and finally its size can lead to food disorders in the population of this other enclosure. Finally, the residual stocks are potentially capable of disturbing the operation of the valve itself. This requirement of integral delivery of each dose of feed is naturally more crucial as the network is more complex and has more branches.

One of the goals of the presently disclosed embodiment is to propose a distribution valve improving the sealing without a retention zone and while reducing the wear of the mechanical parts in order to improve the service life of the distribution valve.

### SUMMARY

The presently disclosed embodiment aims to overcome these disadvantages.

For this purpose, the presently disclosed embodiment is aimed at a distribution valve positioned in a supply pipe, said distribution valve comprising a body between a first end and a second end, said first end is substantially flat in which an inlet orifice is positioned, the inlet orifice has a circular shape and comprises an axis of revolution positioned according to a parallel of the longitudinal axis of the distribution valve, the second end is substantially flat and comprises a spherical cap on which at least two outlet orifices are positioned, each outlet orifice has a circular shape, said distribution valve comprises a mobile plug contained in the distribution valve body, said mobile plug comprises a rigid duct that passes through it and is adapted for selectively making the inlet orifice communicate with one of the outlet orifices.

Thus, the joint plane of the spherical cap provides better sealing at high pressures, for reduced wear and increased mechanical reliability.

The distribution valve is entirely made of stainless steel (version 316L). The motorization is electric or pneumatic in order to make the mobile plug rotate. The distribution valve is compact, sealed on all the paths, multiport PS6 bar.

According to an example of realization, the distribution valve allows powders to be distributed. According to another example of realization, the distribution valve allows fluids to be distributed. The fields of use are the agri-food industry, pharmacy, cosmetics . . .

The disclosed embodiment is advantageously implemented according to the aspects and the alternatives disclosed below, which are to be considered individually or according to any technically effective combination.

In one aspect of the disclosed embodiment, the valve body has a cylindrical circular or rectangular shape.

In one aspect of the disclosed embodiment, the mobile plug is rigid.

The rigid plug allows to guarantee strength. The mobile plug has an inner diameter that is integral and continuous.

In one aspect of the disclosed embodiment, the mobile plug is sealed with respect to the supply pipe.

In one aspect of the disclosed embodiment, the mobile plug comprises a tip mounted as a sliding pivot on the mobile plug in contact with the spherical cap by a return means, the tip being adapted for creating the seal between the mobile plug and one of the outlet orifices.

In one aspect of the disclosed embodiment, the mobile plug is coupled with a motor by a gear adapted for selectively making the inlet orifice communicate with one of the outlet orifices.

In one aspect of the disclosed embodiment, the distribution valve comprises a disengageable device adapted for cutting off the communication between the inlet orifice and one of the outlet orifices. A manual disengagement allows the user to take control of the system at any time in particular in the case of maintenance.

In one aspect of the disclosed embodiment, the spherical cap comprises a mobile disc coupled with the mobile plug and articulated about an axis.

In one aspect of the disclosed embodiment, said distribution valve being positioned in a system for distribution of granules for the farming of aquatic animals.

### BRIEF DESCRIPTION OF THE DRAWINGS

Other advantages, goals and features of the presently disclosed embodiment are clear from the description that is made, with an explanatory and in no way limiting goal, in relation to the appended drawings, in which:

FIG. 1, a diagram of an example of installation of the system comprising elements of a specific aspect of the system that is the object of the presently disclosed embodiment,

FIG. 2, a diagram of an example of certain elements of a specific aspect of the system that is the object of the presently disclosed embodiment,

FIGS. 3 to 5 explain the operation of distribution of the pellets according to a specific aspect of the system that is the object of the presently disclosed embodiment,

FIG. 6 shows a curve of the adjustment of the variator of the air pumps,

FIG. 7 shows a view of the distribution valve according to a specific aspect of the system that is the object of the presently disclosed embodiment,

FIG. 8 shows a view of the distribution valve without the body of said distribution valve according to an aspect of FIG. 6,

FIG. 9 shows the mobile plug according to a specific aspect of the disclosed embodiment,

FIG. 10 shows a view of the distribution valve with a cutaway of the supply pipe in which the pellets are visible,

FIGS. 11 and 12 show the disengageable operation of the distribution valve, and

FIG. 13 shows a view of details of the spherical cap.

### DETAILED DESCRIPTION

The system for distribution of granules for the farming of aquatic animals is modular, automatic and autonomous and adapts to numerous existing farms. It allows the dosage and the distribution of powders (pellets) for the farming of animals. It allows to precisely deposit in one point or a plurality of simultaneous points or alternatively pellets, regardless of the distance to be covered and regardless of the particle size distribution (200 microns to Ø12 mm), and the weight (several grams to several tons).

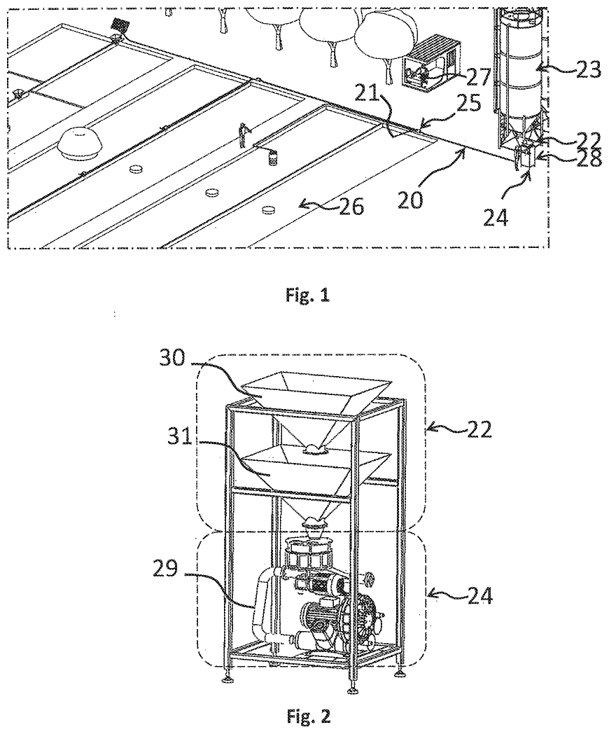

FIG. 1 shows an example of installation of the system.

The system for distribution of granules for the farming of aquatic animals, comprising a pipe 20 for supply via jet of air adapted for supplying granules to at least one delivery point 21 of a farming tank 26. In another example, there is a plurality of delivery points 21 for the same tank. The system also describes a device 22 for dosing granules comprising a zone for storage of granules with an outlet. The storage zone is represented by silos.

The system also describes a device 24 for distribution of granules comprising an inlet of granules connected to the dosing device 21 and an outlet connected to the supply pipe 20.

The system describes a distribution valve 25 positioned in the supply pipe 20. The distribution valve 25 comprising an inlet orifice and at least two outlet orifices. According to alternatives that are not shown, the distribution valve comprises three, four, five . . . outlet orifices.

The system describes at least one farming tank 26. In this drawing, there is a plurality of tanks. Each tank comprises a sensor for measurement (not shown) of the aquatic environment selected from: a temperature sensor, a sensor of the concentration of nitrate, a sensor for measuring oxygenation, a turbidity sensor, a sound-level sensor.

According to another example, all these sensors measure a single farming tank. If there is a plurality of tanks, each tank comprises a plurality of sensors of measurements.

The system describes a connected terminal 27 adapted for the reading of information of the system and the control of distribution of food. This drawing shows a user in a booth and another user at the level of the distribution device 24. There is another connected terminal at this location.

The protocol for transfer of the pellets is done through a supply-pipe network and realized by multiport distribution valves. The number of ports is not limited. In theory, an infinite number of ports can be imagined. These valves allow the stream of pellets to be distributed to the selected point of delivery, in the example shown here above a tank. The supply-pipe network, in which the supply pipes divide at each distribution valve, thus creating a network. In this pisciculture example, the supply pipe has a nominal diameter of DN 50.

The entire supply pipe (piping) is configured to not alter the pellet, namely: elbows very large radii (neutral-axis radius min. of R400 mm for an inner diameter of 50 mm or a curve qualified as 8R), positive gravitational ascent of less than 30 cm over a slope of 20° maximum.

The network is composed of main pipes called hereinafter “Main line” which start from the distribution device, then run along the rows of tanks. Fish farms consist of one or more rows of tanks. Between two tanks, a distribution valve is disposed. This distribution valve is mainly composed of two ports, that is to say two orifices of outputs. According to another example, the distribution valve comprises three ports in the standard version, but one port is voluntarily plugged in order to create an orifice for maintenance. In another example, the distribution valve is offered in a three-port version. For example the third port allows the maintenance of the pipe.

From this distribution valve, a pipe runs along the separation of two tanks. Along this pipe, a plurality of three-port valves are disposed there at a given interval. Having a plurality of distribution valves allows to have a plurality of delivery points in the same tank.

This pipe is called “daughter line”; it allows two tanks to be distributed, leaving the access to the other adjoining tank for the fish farmer.

The three last tanks of a row are managed by a single three-port distribution valve, in order to save a valve.

FIG. 2 shows certain elements of a specific aspect of the disclosed embodiment of the system.

This drawing shows the dosing device 22 and the distribution device 24.

In the distribution device 24, before the air touches the pellet, there is according to this aspect of the disclosed embodiment a heat exchanger. The heat exchanger consists of a double cooling envelope. Water is drawn by a pump in the river and is released therein. The water inlet is in water point. The outlet cross-section is reduced by a calibrated orifice in order to allow the filling of the exchanger. The inlet flow rate is greater than the outlet flow rate, ensuring the filling. The time for heating of the air is less than the time for filling the exchanger. The exchange surface of the manifold is calculated, in order to not need temperature regulation or a solenoid valve. The cooling device is controlled by the control unit and using temperature measurement, the cooling device comprises a drainage of the heat exchanger via the effect of gravity, namely in order to preserve the heat exchanger in the case of freezing.

This drawing shows a weighing hopper 30 adapted for weighing a quantity of granules and a delay hopper 31 is positioned between the weighing hopper and the inlet of the device for distribution of granules.

The weighing hopper 30 is placed on spring scales and allows to weigh the desired quantity of granules.

This double-hopper principle allows weighing concurrently with the phase of injection of the pellets.

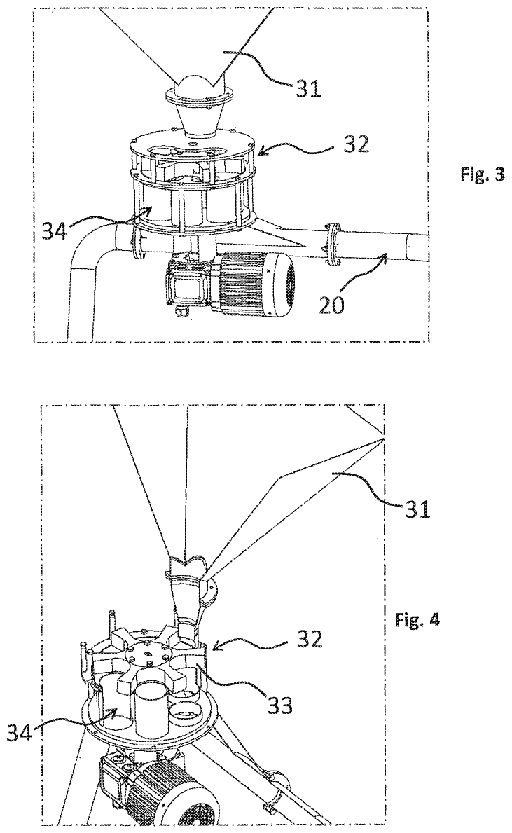

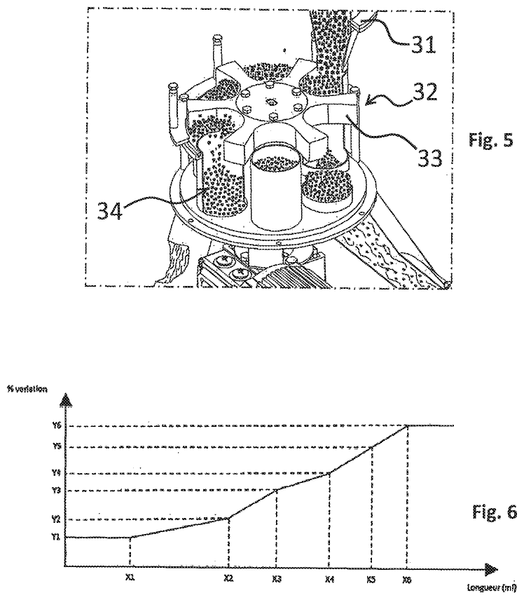

FIGS. 3 to 5 explain the operation of distribution of the pellets. The granules are shown only in FIG. 5. FIGS. 4 and 5 are cross-sectional views.

After the inlet of granules in the device 24 for distribution of granules there is a rotary separator 32 adapted for separating the quantity of granules into at least two portions. In the example shown, the rotary separator 32 comprises six blades 33.

Each portion of granules falls via the effect of gravity into a container having a cylindrical shape of a rotary drum 34. The container has a volume greater than the volume of each granule portion.

After rotation of the drum 34 by one step, the container is in a sealed position, then according to another step, the volume falls via an effect of gravity into the supply pipe.

In one alternative, the rotation is continuous.

The drawing shows two stages, the first stage corresponds to the rotary separator 32 provided with blade 33 and the second stage corresponds to the rotary drum 34.

The pellets fall into the first stage of the rotary separator 32. The first stage consists of six rotary compartments separated by a blade 33. The first stage and the second stage are separated by a plate fastened to the frame onto which the pellets fall. The plate is open at certain places in order to make the pellets fall via effect of gravity from the first stage to the second stage. The openings are diametrically opposite to the delivery point (180°). The rotary separator 32 drives the volume of pellets in rotation over 180°, in order to deposit it delicately into the containers of the rotary drum 34.

The second stage comprises containers, the volume of which is equal to 75% of the volume of the 6 rotary compartments.

The principle is to never fully fill an injector, in order to not grind the pellet. Indeed, a shearing is possible between the parts in rotation and the plate. The angular position of the containers and blades 33 is adjusted to avoid any grinding.

Likewise, the supply pipe containing pressurized air and the second stage are separated by a plate (or sheet) that is fixed to the frame. An opening is made in the plate. The opening is diametrically opposite to the point of filling of the containers) (180°). The rotation of the drum drives the volume of pellets in rotation over 180°, in order to deposit it delicately in the flow of air.

The two stages (rotary separator 32 and rotary drum 34) are driven by the same axis. The motorization of this axis uses a gear motor composed of a brake and of a variator. Like the double hoppers, the rotary separator 32 and the rotary drum 34 allow a separation concurrent with the injection of the pellets into the supply pipe by a nozzle. This nozzle favours the flow of the stream of pellets by the pressurized air. According to the rate of the pump, the instantaneous acceleration that a single pellet undergoes is significant.

According to one alternative, and in order to not degrade the pellet, a tangential nozzle is positioned under the injection point.

### Mode of Transfer: Flow Rate/Weight Proportional:

In order to adjust the energy consumption (ecological notion) and the speed of the pellets necessary and sufficient in order to not degrade them, the motor of the air pump is coupled with a variator in order to allow a management of the power proportionally to the distance from the delivery point. Each valve position (distance) with respect to the valve that precedes it is recorded in the system. Thus the distance to be covered by the pellets is assigned for each valve. Thus, the system also allows to counter the pressure drops.

FIG. 6 shows a curve of the adjustment of the variator of the parameterisable air pumps which depends on the configuration of the site and on the number of elbows in particular).

According to this example, in a standard version with two elbows and 5 valves on the trajectory of the pellet stream this gives:
Y1=30%-x1=0
Y2=40%-x2=25 m
y6=100%-x6=300 m (data for a pump giving 385 mBar 580 m3/h)

Control of the variator of the air pump:
a. The starting of the air pump is carried out in twenty seconds before the introduction of the pellets into the flow of air (this time will be parameterisable).
b. The control of the variator is carried out according to the pressure drop of the piping up to the valve. A curve with six adjustable points allows to obtain the setting of the variator.
c. One length per valve is assigned for the calculation of the overall length (length from previous valve, parameterisable).
d. The delay of stoppage of the air pump will be proportional to the length of the piping. This function will be parameterisable according to the length of piping and a coefficient k.

According to the type of pellet (fragility) and the pellet particle size distribution the quantity of pellets injected per unit of volume of air is proportional. For example, when considering pellets with Ø2 mm (A) and Ø9 mm pellets (B), with an equal weight of pellets A+B, and an equal distance to cover (identical air pump settings), the average distance between the pellets at the outlet of the distribution device is greater for A than for B. The more the distance to be covered is increased, the more the average distance between the pellets increases. The stream of pellets collapses in order to form a river of pellets at the low point of the supply pipe (test on a pipe placed on perfectly flat ground): there is a phenomenon characteristic of a mass too great to be transported. The distribution power is greatly reduced. For this reason, with an equal distance to cover, a pellet with a high mass will be harder to transport than a light pellet. The motor of the rotary drum involves a variator. The object is to control the distribution power in kg/min, by controlling the average distance between the pellets characteristic of the mode of flow of powders, while avoiding the “river” phenomenon according to the delivery target and the diameter of the pellet.

Below is an example of calculation of data of the system for a type of pellet.

1 revolution=1 kg at a density 1.6 litres per kg over 6 compartments or 1 compartment equals 166.67 gr

| type of pellet | 1 | 2 | 3 | 4 | 5 | 6 | 7 |
|---|---|---|---|---|---|---|---|
| diameter pellet | 1.9 | 3 | 4.5 | 6.5 | 9 | 11 | 12 |

Nominal speed of rotation (calculation basis):
Floating pellet (density=1.2)=20 rpm or 20 kg/min (parameterisable at the display) with L=150 m.
Semi-floating pellet (density=1.4)=20 rpm or 20 kg/min with L=125 m.
Sinking pellet (density=1.6)=20 rpm or 20 kg/min with L=100 m.

Rule for correction speed of the drum according to the distance and the type and the diameter of the pellet:

Rule for optimization of the transfer.

Reduction of 1 rpm per 20 m via the variator with a limit of 10 kg/min starting with L fixed.

Beyond the power of the pump is increased by 5% per 20 m limit at 100%.

The simplified dosage functions allow to eliminate the need for this function and to force a number of kg/min by accessing the control terminal.

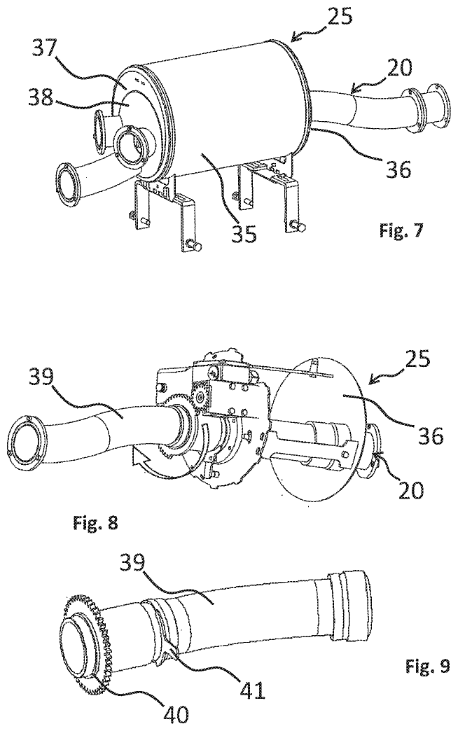

FIGS. 7 and 8 show a view of distribution valve 26.

The distribution valve 26 comprises a valve body having a circular cylindrical shape between a first end 36 and a second end 37.

The first end 36 is flat in which the inlet orifice is positioned. The inlet orifice has a circular shape and comprises an axis of revolution positioned according to a parallel of the longitudinal axis of the distribution valve.

The second end 37 is flat and comprises a spherical cap 38 on which the outlet orifices are positioned. Each outlet orifice has a circular shape.

The distribution valve 25 comprises a disengageable device adapted for cutting off the communication between the inlet orifice and one of the outlet orifices.

The distribution valve 25 comprises stainless steel.

In another alternative, the distribution valve 25 is made of stainless steel.

The distribution valve 25 is sealed up to 6 bar (static pressure).

The connection to the exiting piping is of any food-compliant type, for example according to the standards NF (acronym for norme frangaise), DIN (acronym for Deutsches Institut Normung), SMS (acronym for Swedish Metric Standard) . . .

According to examples of realization, the SMS connector is composed of a male connector, a female connector, a joint for the sealing as well as a nut for connecting the two connectors; the DIN connector: composed of a male connector, a female connector, a joint for the sealing as well as a nut for connecting the two connectors; the MACON connector (registered trademark): composed of a male connector, a female connector, a joint for the sealing as well as a nut for connecting the two connectors; the CLAMP connector (registered trademark): composed of a male connector, a female connector, a joint for the sealing as well as a collar for connecting the two connectors.

FIG. 9 shows the mobile plug 39.

The distribution valve 25 comprises a mobile plug 39 contained in the distribution valve 25 body 35. The mobile plug 39 comprises a rigid duct that passes through it and is adapted for selectively making the inlet orifice communicate with one of the outlet orifices. The mobile plug is mobile in rotation and allows to ensure the sealing between the inlet orifice and one of the outlet orifices. The rotation is carried out at one of the ends of the mobile plug, the end which is located near the inlet orifice of the distribution valve 25.

The mobile plug is curved by an angle of approximately 20°, according to a neutral-axis radius of curvature of R400 mm.

The mobile plug 39 is rotated by a motorized system. At the ends of the elbow stainless steel parts are welded. At the inlet an axis receives a toothed wheel 40; this part is also used as a rotation guide. A flag, is welded there precisely with respect to the plane of curvature. It allows to stop the rotation of the motor. At the end of the mobile plug there is a stainless steel sleeve that receives a circular cylindrical part of revolution made of PTFE (acronym for polytetrafluoroethylene) with a sliding pivot link.

Between the stainless steel sleeve and the cylindrical part a spring, not shown, is positioned. According to another alternative, it is a joint made of elastomer.

This spring pushes the cylindrical part onto the spherical cap, in order to guarantee the sealing.

### Management of the Real Time

The particle size distribution and the weight to be distributed for each tank are defined by a specific piece of feeding software. The daily weight to be distributed is defined by the number of fish in the tank, its age, its size, its species, the season, the environment (quality of the water, presence of predators . . . ), the geographic conditions (altitude, environment, etc.), the climatic conditions (atmospheric pressure, T° C. of the water, T° C. of oxygen . . . etc.).

All the analogue signals (type 0-10V, 4-20 mA, 0-20 mA) below, are connected to the system, and are retransmitted in real time to the operator (maximum frequency of transmission limited to the polling speed of the system, or less than 8 ms): (non-exhaustive list)

T° C. water: setting for correction or stoppage of feeding upon high and low threshold. According to one example, if the temperature is greater than 6.5° C. then stoppage of feeding.

sound: setting to stop feeding of the tank upon low threshold. Level of sound activity is characteristic of low appetite (non-blocking alarm). According to one example, if the threshold reaches 20 db then stoppage of the feeding.

Turbidity: setting to stop feeding of the tank upon high threshold. According to one example, if turbidity is greater than 1 NTu (for Nephelometric Turbidity Unit) then stoppage of feeding.

O2 control: setting to stop feeding of the tank upon low threshold. According to one example, if O2 is greater than 10 mg/litre stoppage of feeding, then starting of aerator and oxygenator.

NH4 control: setting to stop feeding of the tank upon high threshold. According to one example, if the pH is outside of the 6.8 to 8 range then feeding is stopped.

For each of these signals, an alert threshold is defined by the operator at the connected terminal of the system.

The system sends the information of the exceeding of the threshold to the control unit and to the connected terminal.

The system triggers the actions defined by the protocol:

In terms of security: the system safeguards the tank and informs the connected terminal of the level of security. In security mode the system takes the decision to act alone but always informs the connected terminal.

The control unit comprises:

a database of information on the quantity of granules to distribute for a tank,

a means for processing the data of the database in order to send the information on the quantity of granules to the dosing device for a tank,

a means for processing the data of the database in order to send a jet of air proportional to the distance from the delivery point,

a communication means adapted for exchanging the sensor data with the connected terminal.

The control unit is controlled by the connected terminal.

### Adjustment of the Pump

The power of the pump is adjusted according to the length of the delivery point and the density of the pellet.

For each distribution valve the distance of piping to the dosing apparatus is recorded upon launch for all the tank distribution valves of the daughter lines (not the distributions on the main lines): tank by tank, valve by valve. The distance entered by the operator is the distance to the distribution valve upstream.

The speed of rotation of the rotary drum is adjusted to the distribution capacity in kg/min.

According to one alternative, a delay exists between two distributions of pellets. A drainage of the tank line of the residual deposit of pellet: that is to say after the end of distribution, the air pump is maintained at 100% of its operation for a time.

The delay of stoppage of the air pump will be proportional to the length of the piping. This function will be parameterisable according to the length of piping and a coefficient k.

The piping is sealed on all the paths.

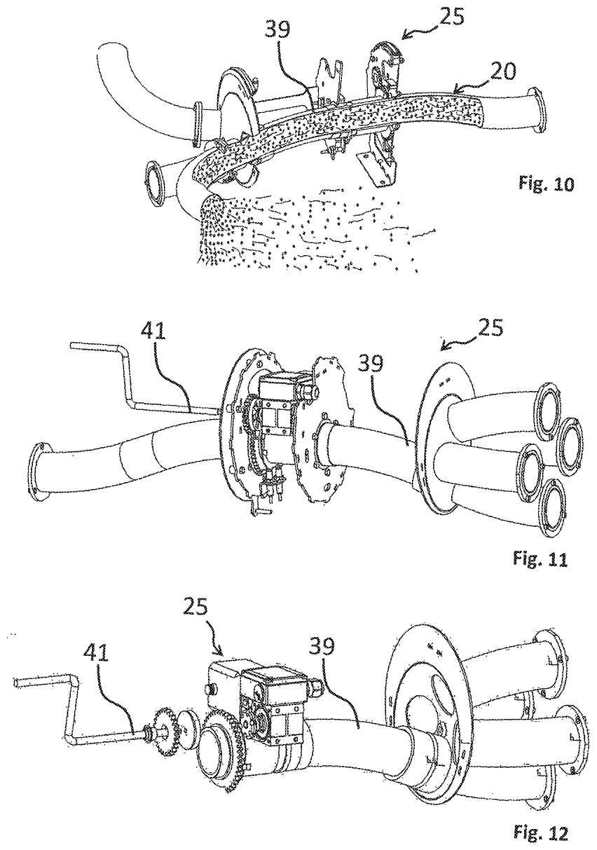

FIG. 10 shows a view of the distribution valve 25 with a cutaway of the supply pipe 20 in which the pellets are visible.

FIGS. 11 and 12 show the disengageable operation of the distribution valve 25.

The distribution valve 25 comprises an insert for a crank 41 and allows for the manual disengagement.

In this example, the valve has four output orifices.

The mobile plug 39 is coupled with a motor by a gear adapted for selectively making the inlet orifice communicate with one of the outlet orifices. The mobile plug is rigid.

The disengageable device is adapted for cutting off the communication between the inlet orifice and one of the outlet orifices for the maintenance of the distribution valve. The disengageable device comprises toothed wheels coupled with a disc having a hole having a rectangular shape and allows the driving of the mobile plug to be uncoupled.

When the crank 41 is inserted into the disk, the end of the crank pushes a toothed wheel in order to uncouple the gear of the mobile plug with the drive motor.

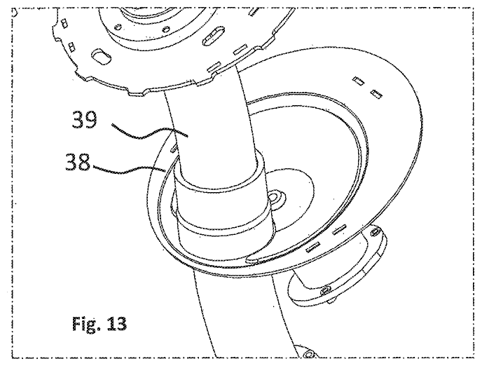

FIG. 13 shows a view of details of the spherical cap 38. The spherical cap 38 comprises, in addition, an articulated mobile disc of an axis which follows the mobile plug and ensures the sealing.

The mobile plug 39 comprises a tip mounted as a sliding pivot on the mobile plug in contact with the spherical cap by a return means. The tip being adapted for creating the seal between the mobile plug and one of the outlet orifices.

### NOMENCLATURE

20 supply pipe
21 delivery point
22 dosing device
23 zone of storage of granules
24 distribution device
25 distribution valve
26 farming tank
27 connected terminal
28 control unit
29 cooling device
30 weighing hopper
31 delay hopper
32 rotary separator
33 blade
34 rotary drum
35 distribution valve body
36 first end of the distribution valve body
37 second end of the distribution valve body
38 spherical cap
39 mobile plug
40 toothed wheel
41 crank

What is claimed is:

1. A distribution valve positioned in a supply pipe, said distribution valve comprises:
a body between a first end and a second end, said first end is substantially flat in which an inlet orifice is positioned,
the inlet orifice has a circular shape and comprises an axis of revolution positioned according to a parallel of the longitudinal axis of the distribution valve,
the second end is substantially flat and comprises a spherical cap on which at least two outlet orifices are positioned, each outlet orifice has a circular shape,
said distribution valve further comprises a mobile plug contained in the distribution valve body, said mobile plug comprises a rigid duct that passes through it and is adapted for selectively making the inlet orifice communicate with one of the outlet orifices.

2. The valve according to claim 1, wherein the valve body has a cylindrical circular or rectangular shape.

3. The valve according to claim 1, wherein the mobile plug is rigid.

4. The valve according to claim 1, wherein the mobile plug is sealed with respect to the supply pipe.

5. The valve according to claim 1, wherein the mobile plug comprises a tip mounted as a sliding pivot on the mobile plug in contact with the spherical cap by a return means, the tip being adapted for creating the seal between the mobile plug and one of the outlet orifices.

6. The valve according to claim 1, wherein the mobile plug is coupled with a motor by a gear adapted for selectively making the inlet orifice communicate with one of the outlet orifices.

7. The valve according to claim 1, wherein the distribution valve comprises a disengageable device adapted for cutting off the communication between the inlet orifice and one of the outlet orifices.

8. The valve according to claim 1, wherein the spherical cap comprises a mobile disc coupled with the mobile plug and articulated about an axis.

9. The valve according to claim 1, wherein said distribution valve being positioned in a system for distribution of granules for the farming of aquatic animals.
